(19) United States
(12) Patent Application Publication
(10) Pub. No.: US 2019/0096420 A1
(43) Pub. Date: Mar. 28, 2019

(54) METHOD AND APPARATUS FOR AUDIO FILTER TO BLOCK NOISE FROM COMMUNICATION DEVICES

(71) Applicant: Tyler Tran, Saratoga, CA (US)

(72) Inventor: Tyler Tran, Saratoga, CA (US)

(21) Appl. No.: 15/718,343

(22) Filed: Sep. 28, 2017

(51) Int. Cl. G10L 21/0232

(52) U.S. Cl. CPC G10L 21/0232; G10L 2021/02163

(57) ABSTRACT

An apparatus and method to detect a desired audio frequency range of a signal and enabling or disabling a communications device to allow the desired audio signal to pass through.

### FIELD OF THE DISCLOSURE

The present disclosure relates to communication systems (such as mobile devices, communication devices, and computer systems) and, more particularly, to mechanisms and techniques for audio filter and control of the audio communication.

### BACKGROUND

In general, communication devices are widely used for conference calls, personal calls, and group calls such as in video game participation. The advance of internet, digital design, mobile devices, international design teams allow talents from all over the world to work together with projects that require constant oral communication. In addition, online video games are very popular with youths where many collaborate and play games with constant oral communication.

There are attempts to reduce or block the distance noise in audio transfer. Unfortunately, not all unwanted noises are blocked, or too many desired signals are blocked during communication. For example, the keyboard typing noises cause interference with other participants during the call. It is often that the participant must manually mute or unmute his microphone. Spontaneous reaction during an online video game is not possible. The current disclosure provides the cost efficient way to block more unwanted noise than traditional methods, therefore improving the quality of the microphones.

### BRIEF DESCRIPTION OF THE DRAWINGS

The present disclosure may be better understood, and its numerous features and advantages made apparent to those skilled in the art by referencing the accompanying drawings. Embodiments of the present disclosure are illustrated by way of examples and are not limited by the accompanying figures, in which like references indicate similar elements. The use of the same reference symbols in different drawings indicates similar or identical items. Elements in the figures are illustrated for simplicity and clarity and have not necessarily been drawn to scale.

FIG. 1 is a frequency spectrum of human voice in accordance with the present disclosure.

FIG. 2 is a frequency spectrum of keyboard background noise in accordance with the present disclosure.

FIG. 3 is a block diagram of an embodiment of an audio filter to block noise in a system in accordance with the present disclosure.

FIG. 4 is a block diagram of a band pass filter to detect a specific frequency range in accordance with the present disclosure.

FIG. 5 is a block diagram of a detection logic to enable an analog switch in accordance with the present disclosure.

### SUMMARY

The problems outlined above are in large part solved by a design in accordance with the various embodiments of this disclosure. Embodiments of this disclosure are adaptable for use in any audio device, computer system, or other digital design.

In particular, the disclosure contemplates on using the audio filter mechanism that will conditionally enabling or disabling of the microphone to block unwanted noise as desired. The audio module uses the band-pass filter(s) paired with threshold detection to switch the microphone on and off automatically when the desired voice frequency is received. The audio filter includes option for multiple voice frequencies as well as adjustable features.

This disclosure provides various embodiments of mechanisms to allow audio pass-through only when there is a need for valid audio communication.

A further understanding of the nature and advantages of the present disclosure may be realized by reference to the remaining portions of the specification and the drawings.

### DETAILED DESCRIPTION

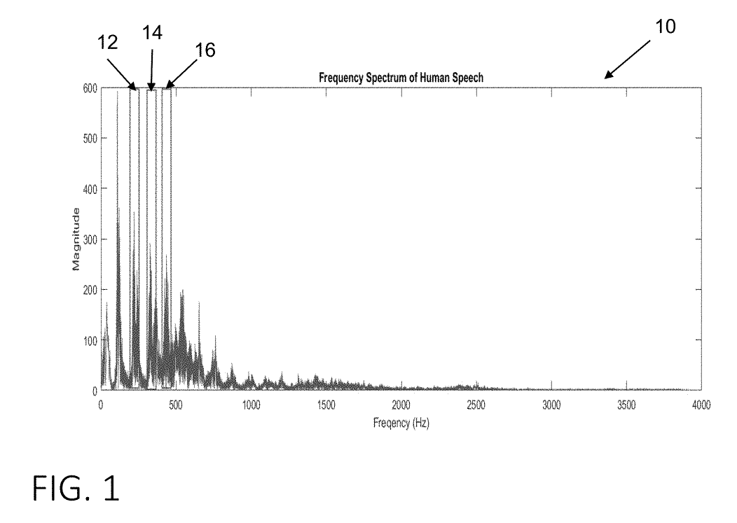

FIG. 1 illustrates a frequency spectrum graph 10 of a human voice, the characteristics of this particular voice are highlighted in graph 10, by the frequency ranges shown in 12, 14 and 16. Range 12 is a frequency range approximately between 180 Hz and 250 Hz. Range 14 is a frequency range approximately between 290 Hz and 360 Hz. Range 16 is a frequency range approximately between 400 Hz and 450 Hz. In this example of this embodiment, this voice can be detected by detecting a magnitude threshold of these three frequency ranges. This detection can be then used to enable or disable a microphone. In another embodiment, the voice can be in different frequency ranges. Female voice and male voice are often at different frequency ranges and magnitude threshold.

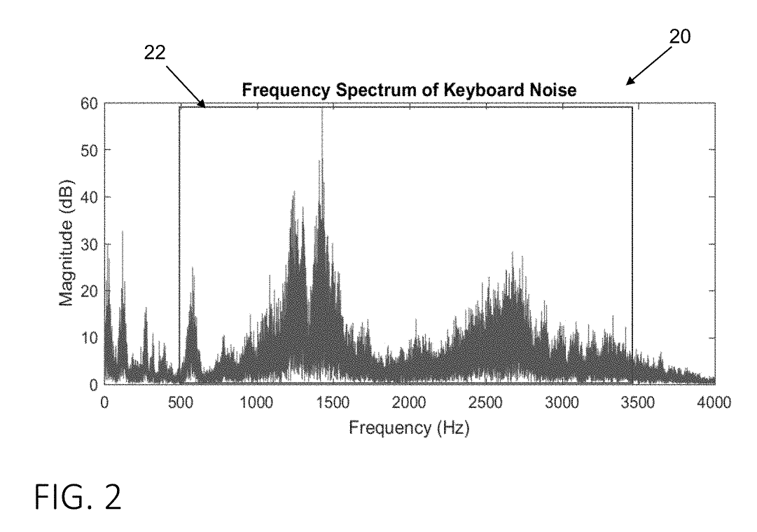

FIG. 2 illustrates a frequency spectrum graph 20 of keyboard noise. This noise is generally unwanted noise in communication. Range 22 is a frequency range approximately between 500 Hz and 3000 Hz. Frequency range 22 contains most of the higher magnitudes of this unwanted noise, they are notably outside of the main frequency components of the human voice as shown in graph 10. Range 22 also contains large amounts of noise which contributes to the quality of a human voice. The keyboard noise is an example of this embodiment, there may be other types of unwanted noise at different frequency ranges and magnitude.

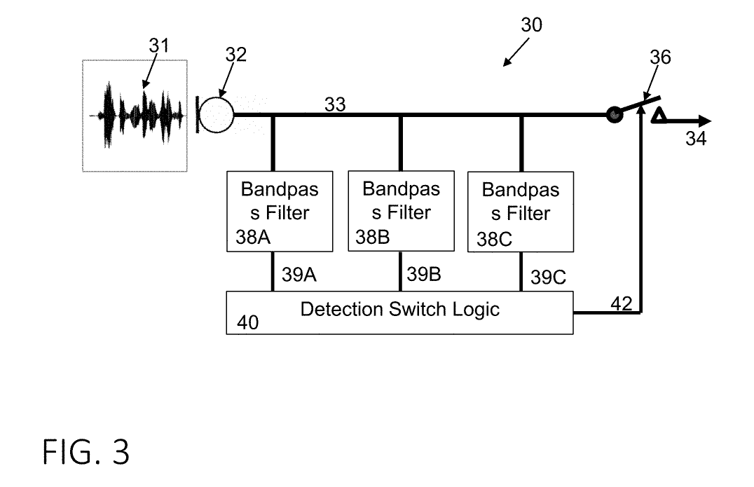

FIG. 3 illustrates a block diagram 30 of audio filter to block noise from communication devices in accordance to present disclosure. Block diagram 30 includes the audio input signal 31, the input microphone 32, the output signal 34, the analog switch 36, the band-pass filter array 38, and the switch logic 40. The input signal 33 is the input signal typically from a microphone 32. The output signal 34 is the analog signal passed to the computer, the smart phone, or other communication device. The analog switch 36 is a switch such as the Texas Instruments SN74LVC1G3157, which disconnects or connects input signal 33 to output signal 34 based on an enable input signal 42 from the detection switch logic 40. The band-pass filter array 38 consists of multiple bandpass filters, 38A, 38B, and 38C of different frequency ranges, such as the frequency ranges, 12, 14 and 16 of graph 10. The switch logic 40 receives signals, 39A, 39B, and 39C from the band-pass filter array 38, and outputs a digital enable signal 42 to the analog switch 36.

When an audio input 31 is received by the microphone 32, the input signal 33 comes in from microphone 32, the signal 33 is filtered with the band-pass filter array 38, filtering it into small frequency ranges. In this embodiment of present disclosure, the band-filter array consists of three band-pass filters detecting the ranges 12, 14 and 16 of graph 10. The number of band-pass filter components in the band-pass filter array 38 can be a single band-pass filter to detect a single frequency range, or multiple band-pass filters to detect multiple frequency ranges respectively. In another embodiment, the band-pass filter array 38 consist of multiple frequency ranges to detect more than 1 human voice. These frequency ranges are checked for a magnitude threshold, and they all must meet the threshold to output a digital enable to the analog switch 36. For example, a whisper may not trigger the audio filter 30 to switch on the analog switch 36. The combination of the band-pass filter array 38 and the switch logic 40, forms a simple voice detection system, which when paired with the analog switch 36, lets the original signal 33 pass through to the output 34, when this human voice is detected.

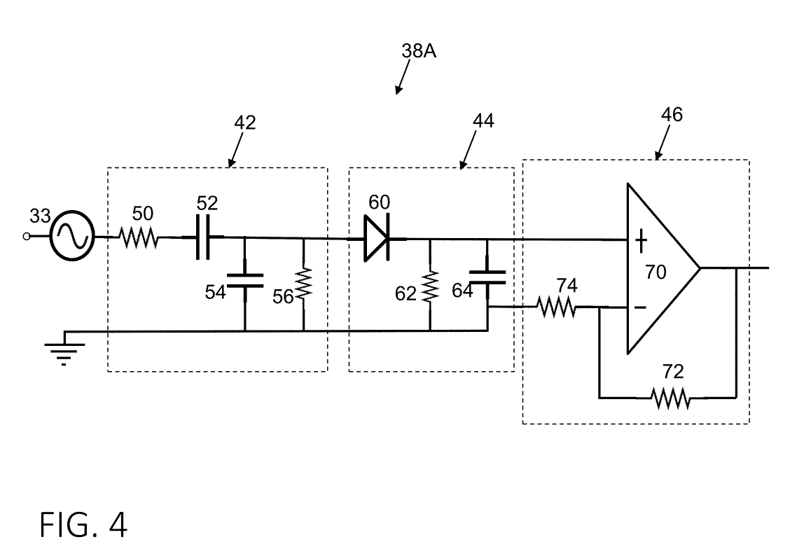

FIG. 4 is a diagram of an embodiment of band-pass filter components for a single bandpass filter 38A that can be included in the bandpass filter array 38 on FIG. 3. The band-pass filter component includes the band-pass filter 42, an AC-DC converter 44, and an amplifier 46. The band-pass filter 42 contains components: resistor 50 in series with capacitor 52 in series with the combination resistor 54 in parallel with capacitor 56. In one embodiment, the components 50, 52, 54 and 56 are variable valued components, as these comprise the band-pass filter and may be adjusted to fit different frequency ranges. The AC-DC converter 44 is comprised of a diode 60 in series with the combination of resistor 62 in parallel with capacitor 64. The components 60, 62, and 64 are fixed components which are commonly used as a half wave rectifier to convert AC to DC. The amplifier 46 is comprised of components an operational amplifier 70, a resistor 72 and a resistor 74. Components 72 and 74 are variable components which are changed to adjust the magnitude threshold of the detection system. When the frequency range of the audio input signal 33 is detected by the band-pass filter 42, converting to DC signal by AC-DC convertor 44 and amplified by the amplifier 46 to generate a valid frequency range detection with a magnitude threshold.

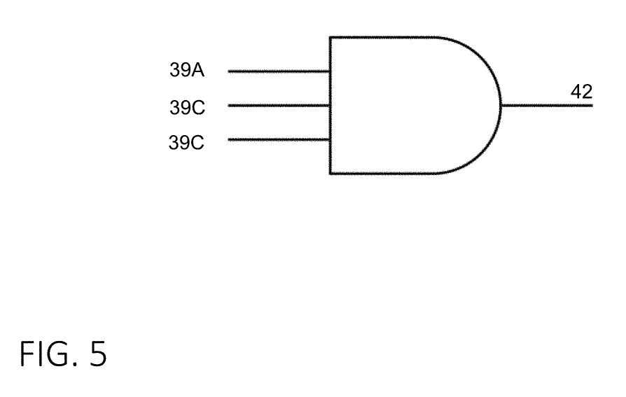

FIG. 5 is a diagram of an embodiment of the switch logic components that can be included in the switch logic 40 on FIG. 3. The switch logic is comprised of a three-input AND gate to detect three outputs, 39A, 39B, and 39C from the band pass filter array 38, and enable the analog switch 36. In another embodiment when there is a single band-pass filter, the AND gate is not needed, the output of the amplifier 46 can be passed directly to the analog switch 36. Yet in another embodiment, the band-pass filter 38 consists of 2 sets of band-pass filter to detect 2 different voice. In this case, two AND gates and one OR gate is used to enable the analog switch 36. In another embodiment, the switch logic 40 includes a delay element such as inverter chain to delay turning off the analog switch 36 of FIG. 3.

In another embodiment, the audio input signal can be converted to a digital signal and a similar process of frequency range detection takes place, but a digital AND gate is used in place of an analog switch.

Some of the above embodiments, as applicable, may be implemented using a variety of different information processing systems. For example, although FIG. 3 and the discussion thereof describe an exemplary audio filter, this exemplary architecture is presented merely to provide a useful reference in discussing various aspects of the disclosure.

Thus, it is to be understood that the architectures depicted herein are merely exemplary, and that in fact many other architectures can be implemented which achieve the same functionality. In an abstract, but still definite sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the functionality of the above described operations merely illustrative. The functionality of multiple operations may be combined into a single operation, and/or the functionality of a single operation may be distributed in additional operations. Moreover, alternative embodiments may include multiple instances of a particular operation, and the order of operations may be altered in various other embodiments.

In one embodiment, the local-clocks of this disclosure is applicable to all digital ICs like custom chip, Application Specific IC (ASIC), Field Programmable Gate Array (FPGA), discrete components. It is applicable to practically any digital design such as processing units, memory systems, communication system, and I/O systems.

In one embodiment, system 100 is an audio communication system such as a personal computer system. Other embodiments may include different types of communication system. Communication systems are signal processing systems which can be designed to prepare signals for communication transmissions for one or multiple users. Communication systems may be found in many forms including but not limited to personal computers, notepads, personal digital assistants, electronic games, automotive and other embedded systems, cell phones and various other wireless devices. A typical communication system includes at least one communication unit, associated memory and a number of input/output (I/O) devices.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical, required, or essential feature or element of any or all the claims.

The term “coupled,” as used herein, is not intended to be limited to a direct coupling or a mechanical coupling.

Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to disclosures containing only one such element, even when the same claim includes the introductory phrases “one or more” or “at least one” and indefinite articles such as “a” or “an.” The same holds true for the use of definite articles.

Unless stated otherwise, terms such as “first” and “second” are used to arbitrarily distinguish between the elements such terms describe. Thus, these terms are not necessarily intended to indicate temporal or other prioritization of such elements.

1. An apparatus comprising:
a digital and audio circuitry comprising;
a frequency filter to allow a certain range of an audio frequency to pass through;
a switch to enable or disable the said audio signal; and
in response to a valid audio amplitude, the said switch allows the said audio signal to be turning on or off.

2. The apparatus of claim 1, wherein the frequency filter consist of multiple band-pass filters for detection of multiple audio frequency ranges.

3. The apparatus of claim 1, wherein the frequency filter is an adjustable bandpass filter which can be controlled by a user or manufacture.

4. The apparatus of claim 1, wherein the frequency filter consists of
an adjustable bandpass filter; and
multiple band-pass filters for detection of multiple audio frequency ranges.

5. The apparatus of claim 1, wherein the switch includes a delayed element before disabling the audio signal.

6. The apparatus of claim 1, wherein the switch is a digital gate.

7. The apparatus of claim 1, wherein the frequency filter is a digital frequency range filter.

8. A method comprising:
receiving an audio signal;
detecting an audio frequency range within the said audio signal;
generating an enable signal for a switching device; and
switching the switch device on or off for the audio signal to pass-through;

9. The method of claim 8, further comprising of detecting multiple audio frequency ranges by using multiple band-pass filters.

10. The method of claim 8, further comprising of detecting adjustable audio frequency range.

11. The method of claim 8, wherein the switching device further comprising of a delay component before disabling the switch.

12. The method of claim 9, wherein the band-pass filter is a digital band-pass filter.

13. In a communication system including a microphone, a speaker, a digital system, and I/O interfacing unit, comprising:
a bandpass filter to detect an audio signal from the microphone;
that detecting an audio frequency range to generate a valid signal;
a switch to enable or disable the audio signal to be received by the communication system:
that using the said valid signal to enable or disable the said switch accordingly.

14. The method of claim 13, wherein the audio frequency range of the bandpass filter within the communication system consists:
multiple frequency ranges; or
adjustable frequency range.
